(19) United States
(12) Patent Application Publication
(10) Pub. No.: US 2026/0106086 A1
(43) Pub. Date: Apr. 16, 2026

(54) ELECTRODE FOIL FOR ELECTROLYTIC CAPACITOR, ELECTROLYTIC CAPACITOR, AND PRODUCTION METHOD FOR ELECTRODE FOIL FOR ELECTROLYTIC CAPACITOR

(71) Applicant: Panasonic Intellectual Property Management Co., Ltd., Osaka (JP)

(72) Inventors: Toshifumi KADOKAWA, HYOGO KEN (JP); Mitsuhisa YOSHIMURA, OSAKA FU (JP)

(21) Appl. No.: 19/114,975

(22) PCT Filed: Sep. 28, 2023
(86) PCT No.: PCT/JP2023/035488

§ 371 Date: Mar. 25, 2025

(30) Foreign Application Priority Data
Sep. 30, 2022 (JP) 2022-158727

(51) Int. Cl. H01G 9/048; H01G 9/045; H01G 9/15

(52) U.S. Cl. CPC H01G 9/048; H01G 9/045; H01G 9/151

(57) ABSTRACT

An electrode foil for an electrolytic capacitor according to the present invention comprises a metal foil that includes a valve metal. The metal foil has a core part and a porous part that is continuous with the core part. The porous part includes a principal surface of the metal foil that has a glossiness G₁ of at least 10 for an incidence angle of 20 degrees.

### TECHNICAL FIELD

The present disclosure relates to an electrode foil for electrolytic capacitors, an electrolytic capacitor, and a method for producing an electrode foil for electrolytic capacitors.

### BACKGROUND ART

An electrode foil in an electrolytic capacitor contains a valve metal, and includes a porous portion and a core portion continuous with the porous portion. An electrode foil with a large surface area can be obtained by the porous portion, and the capacity of the electrolytic capacitor can be enhanced.

Patent Literature 1 proposes an electrode foil for aluminum electrolytic capacitors, characterized in that an aluminum foil having been subjected to surface-enlargement treatment by etching is compressed in the foil thickness direction, thereby to increase the surface area per unit volume to be larger than that before compression.

### CITATION LIST

### Patent Literature

Patent Literature 1: Japanese Laid-Open Patent Publication No. H11-26320

### SUMMARY OF INVENTION

### Technical Problem

The porous portion (etched layer) has still not been sufficiently examined, and further improvement in the performance of electrolytic capacitors is required.

### Solution to Problem

One aspect of the present disclosure relates to an electrode foil for electrolytic capacitors, including a metal foil containing a valve metal, wherein the metal foil includes a core portion, and a porous portion continuous with the core portion, the porous portion has a principal surface of the metal foil, and the principal surface has a glossiness G₁ at an incidence angle of 20 degrees of 10 or more.

Another aspect of the present disclosure relates to an electrolytic capacitor, including a capacitor element, wherein the capacitor element includes a wound body and an electrolyte, the wound body includes an anode foil and a cathode foil wound together with a separator disposed between the anode foil and the cathode foil, and the anode foil includes the above-described electrode foil, and a dielectric layer covering a metal skeleton constituting the porous portion of the electrode foil.

Yet another aspect of the present disclosure relates to a method for producing an electrode foil for electrolytic capacitors, including an etching step of etching a sheet containing a valve metal, to form porous portions on both principal surfaces of the sheet, and a step of compressing the etched sheet in a thickness direction, to provide the principal surfaces with a glossiness G₁ at an incidence angle of 20 degrees of 10 or more.

### Advantageous Effects of Invention

According to the present disclosure, a highly reliable large-capacity electrolytic capacitor can be obtained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic sectional view illustrating an example of an electrode foil for electrolytic capacitors according to one embodiment of the present disclosure.

FIG. 2 A schematic diagram illustrating an example of a compression step in a method for producing an electrode foil for electrolytic capacitors according to one embodiment of the present disclosure.

FIG. 3 A schematic sectional view illustrating an example of an electrolytic capacitor according to one embodiment of the present disclosure.

FIG. 4 A schematic oblique view illustrating the configuration of a wound body of FIG. 3.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” includes the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

### (Electrode Foil for Electrolytic Capacitors)

An electrode foil for electrolytic capacitors according to an embodiment to the present disclosure includes a metal foil containing a valve metal. The metal foil includes a core portion, and a porous portion continuous with the core portion. The porous portion has a principal surface of the metal foil. The principal surface has a glossiness G₁ at an incidence angle of 20 degrees (hereinafter sometimes referred to as a “glossiness Gₛ(20°)”) of 10 or more.

The porous portion includes a large number of pores (pits). One possible way to achieve high capacity is to increase the pit density or the thickness of the porous portion to increase the surface area of the foil. However, increasing the pit density or the thickness of the porous portion reduces the strength of the electrode foil, which may cause cracks in the electrode foil or foil breakage during the production process of an electrolytic capacitor. The reduction in strength of the electrode foil is due to the reduction in strength of the surface layer of the porous portion, and especially when the pit density or the thickness of the porous portion is increased, the reduction in strength of the surface layer becomes noticeable.

As the factors responsible for the reduction in strength of the surface layer of the porous portion, the following (a) to (c) are presumed. (a) During electrolytic etching, an etching solution comes in contact with the surface of the metal foil, due to which the surface layer tends to be degraded. (b) A stress generated when winding the metal foil in the production process of an electrolytic capacitor tends to be great in the surface layer of the electrode foil. The stress becomes great when, for example, the diameter of the roller on which the metal foil is taken up is small. Also, the stress becomes greater on the outer peripheral side of the wound metal foil than on the inner peripheral side. (c) A long length of sheet containing a valve metal (e.g., Al raw foil) used as a raw material of the metal foil is usually a rolled foil, which has rolling marks. The rolling marks tend to remain on the surface layer of the porous portion even after etching.

Against this, by compressing an etched foil, the strength of the surface layer can be considerably increased, and at this time, the glossiness G₁ can be considerably increased. The glossiness G₁ has a tendency to increase as the thickness reduction percentage in the compression increases. In addition, by adjusting the etching conditions (the amount of dissolution of the sheet surface, etc.) to suppress the degradation of the surface layer during etching, the reduction in strength of the surface layer can be suppressed to some extent, and at this time, the glossiness G₁ can be increased to a certain extent.

By the compression of an etched foil, the strength of the surface layer is likely to be improved significantly, and a glossiness G₁ of 10 or more can be easily obtained. When the glossiness G₁ is 10 or more, the reduction in strength of the surface layer that may occur in the case of increasing the pit density or the thickness of the porous portion is suppressed, and the tensile strength of the electrode foil is enhanced. In addition, the capacity per unit volume is sufficiently increased. By using the above electrode foil, it is possible to obtain a highly reliable large-capacity electrolytic capacitor. Furthermore, the retention of electrolyte in the pores of the porous portion is enhanced, and the contact between the dielectric layer and the electrolyte is improved.

In view of suppressing the reduction in strength of the surface layer and improving the capacity per unit volume, the glossiness G₁ is preferably 20 or more, more preferably 40 or more. In view of improving the capacitance, the glossiness G₁ is preferably 140 or less, more preferably 120 or less.

The glossiness Gₛ(20°) is determined in accordance with JIS Z 8741:1997 (the measurement method for “20-degree specular gloss” shown in “Method 5” in “Types of specular gloss-measurement method” in Table 1).

For measurement of the glossiness, a handy glossmeter “PG-IIM” available from Nippon Denshoku Industries Co., Ltd. can be used. The glossiness is measured by making light incident, in parallel to the length direction (rolling direction) of the metal foil (at an angle of 15° to −15° with respect to the length direction) when the metal foil with long length (belt-shaped) is viewed from the direction normal to its principal surface. By this, the influence of light scattering due to the rolling marks on the metal foil can be reduced.

In view of suppressing the reduction in strength of the surface layer and improving the capacity per unit volume, a glossiness Gₛ(60°) at an incidence angle of 60 degrees is preferably 55 or more, more preferably 60 or more. Likewise, a glossiness Gₛ(85°) at an incidence angle of 85 degrees is preferably 82 or more, more preferably 85 or more. In view of improving the capacitance, the glossiness Gₛ(60°) is preferably 180 or less. Likewise, the glossiness Gₛ(85°) is preferably 180 or less.

The glossiness Gₛ(60°) and the glossiness Gₛ(85°) are determined, respectively, in accordance with the measurement method for “60-degree specular gloss” shown in “Method 3” and the measurement method of “85-degree specular gloss” shown in “Method 1”, in “Types of specular gloss-measurement method” in Table 1 of the above JIS standard.

The porous portion has a thickness T, and includes an inner layer region on the core portion side, and a surface layer region on the opposite side to the core portion. The surface layer region is a region within a distance T/4 or less from an outer surface of the porous portion, where the T is a thickness (μm) of the porous portion. The inner layer region is a region within a distance T/4 or less from the boundary between the porous portion and the core portion. When the glossiness G₁ is 10 or more, an average size D₁ (nm) of pores in the surface layer region is smaller than an average size D₂ (nm) of pores in the inner layer region. In the present specification, the term simply referred to as a “size” means a “diameter”.

In view of suppressing the reduction in strength of the surface layer and improving the capacity per unit volume, D₁/D₂ is preferably 0.98 or less, more preferably 0.95 or less, and may be 0.9 or less. In view of improving the capacitance, the ratio D₁/D₂ of the D₁ to the D₂ is preferably 0.5 or more, more preferably 0.55 or more, may be 0.6 or more, and may be 0.7 or more. The range of the D₁/D₂ may be any combination of the above upper and lower limits, and, for example, is preferably 0.5 or more and 0.98 or less, more preferably 0.55 or more and 0.95 or less. When the glossiness G₁ is 10 or more, the D₁/D₂ can be easily adjusted to 0.98 or less.

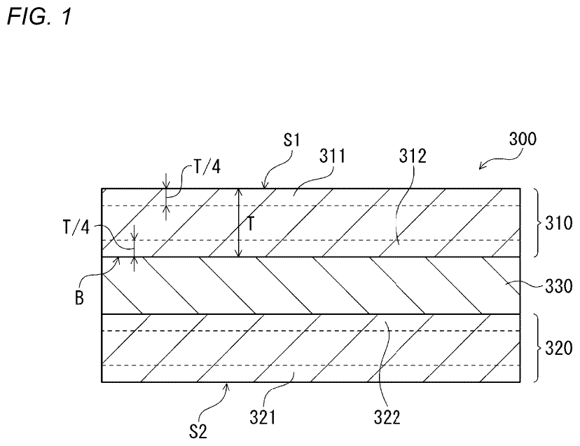

The above D₁ and D₂ can be determined as follows.
(i) A cross-sectional image of the electrode foil is obtained with a scanning electron microscope (SEM). Using the image, the thicknesses at 10 randomly selected points of the porous portion are measured, and the average value thereof is calculated as the thickness T of the porous portion.
(ii) A region within a distance T/4 from the outer surface (surface S1 in FIG. 1) of the porous portion is assumed to be the surface layer region.
(iii) A cross-sectional image of the surface layer region is obtained, and the image is binarized, to distinguish between a region of a metal skeleton constituting the surface layer region and a region of pores (pits) other than the metal skeleton.
(iv) A point within the pore region in the surface layer region is selected, and a line segment passing through the point and crossing the pore region is drawn. The length of the segment when it is shortest is measured. This measurement is performed for 20 randomly selected points within the pore region in the surface layer region, and the average value of the obtained measured values is determined as the average size D₁ of the pores in the surface layer region.
(v) A region within a distance T/4 or less from the boundary (surface B in FIG. 1) between the porous portion and the core portion is assumed to be the inner layer region. The average size D₂ of the pores in the inner layer region is determined in the same manner as in the above (iii) and (iv).

When the glossiness G₁ is 10 or more, a porosity P₁ of the surface layer region tends to be smaller than a porosity P₂ of the inner layer region. In view of suppressing the reduction in strength of the surface layer and improving the capacity per unit volume, P₁/P₂ is preferably 0.95 or less, more preferably 0.92 or less, and may be 0.85 or less. In view of improving the capacitance, the ratio P₁/P₂ of the P₁ to the P₂ is preferably 0.5 or more, more preferably 0.55 or more, may be 0.6 or more, and may be 0.7 or more. The range of the P₁/P₂ may be any combination of the above upper and lower limits, and, for example, preferably 0.5 or more and 0.95 or less, more preferably 0.55 or more and 0.92 or less. When the glossiness G₁ is 10 or more, the P₁/P₂ can be easily adjusted to 0.95 or less.

The porosity P₁ of the surface layer region is determined, using the binarized cross-sectional image of the surface layer region obtained in the above (iii) in the aforementioned process of determining the P₁, by measuring an area S₀ of the entire region of the image and an area S₁ of a region occupied by pores in the image, to calculate (S₁/S₀)×100. The porosity P₂ of the inner layer region can be determined in the same manner as above.

A surface roughness (roughness of the outer surface of the porous portion) Ra of the electrode foil is preferably 1.5 μm or less, more preferably 0.1 μm or more and 1.5 μm or less, and may be 0.5 μm or more and 1.5 μm or less. The surface roughness Ra of the electrode foil means an arithmetic mean roughness, and the arithmetic mean roughness Ra can be determined in accordance with JIS B 0601:2001.

In the case where the surface roughness Ra of the electrode foil is reduced to 1.5 μm or less by a later-described compression step, the influence of the rolling marks can be sufficiently reduced. The surface roughness of the electrode foil can be made smaller than the surface roughness based on the rolling marks of the raw foil, so that any unwanted oxide formed along the rolling marks can be removed. When the surface roughness Ra of the metal foil is 0.1 μm or more, the surface area of the metal foil is sufficiently secured, and large capacity can be easily achieved.

In a pore distribution of the porous portion as measured by mercury intrusion porosimetry, it is preferable to satisfy V_{S1}/V₀≤0.07. It is preferable to further satisfy V_{S2}/V₀≤0.05 (or 0.04). When the glossiness G₁ is 10 or more, the V_{S1}/V₀ (further the V_{S2}/V₀) is likely to fall into the above range.

Here, the V₀ is a cumulative pore volume (cm³/g) for pore sizes of 0.01 μm or more and 1 μm or less. The V_{S1} is a cumulative pore volume (cm³/g) for pore sizes of 0.01 μm or more and 0.06 μm or less. The V_{S2} is a cumulative pore volume (cm³/g) for pore sizes of 0.01 μm or more and 0.05 μm or less. For measurement of the pore distribution, for example, AutoPore V series available from Micromeritics Corporation can be used.

Small pores having a pore size of 0.01 μm or more and 0.06 μm or less (or 0.05 μm or less) tend to be clogged with the dielectric layer and, therefore, are disadvantageous in terms of achieving large capacity and low ESR and securing the strength. In the porous portion, portions where pores are clogged with the dielectric layer not only fail to contribute to improving the capacity, but also become rigid and brittle. When the small pores increase, the above clogged portions increase, and the strength of the electrode foil is reduced, which may cause cracks in the electrode foil or foil breakage during the production process of an electrolytic capacitor (transport of the electrode foil, slitting, take-up, connection by crimping with a lead member, etc.). When the V_{S1}/V₀ (further V_{S2}/V₀) is within the above range, the small pores are few, while many pores having a pore size suitable for improving the capacity are distributed, so that high capacity is likely to be achieved. Furthermore, in this case, the above clogged portions are few, and the reduction in strength can be easily suppressed.

In a pore distribution of the porous portion as measured by mercury intrusion porosimetry, it is preferable to satisfy V_{L1}/V₀≤0.4, and it is more preferable to further satisfy V_{L2}/V₀≤0.1 (or 0.08). When the glossiness G₁ is 10 or more, the V_{L1}/V₀ (further the V_{L2}/V₀) is likely to fall into the above range.

Here, the V_{L1} is a cumulative pore volume (cm³/g) for pore sizes of 0.16 μm or more and 1 μm or less. The V_{L2} is a cumulative pore volume (cm³/g) for pore sizes of 0.5 μm or more and 1 μm or less.

Large pores having a pore size of 0.16 μm or more (or 0.5 μm or more) and 1 μm or less are unlikely to contribute to improving the capacity. Large pores are disadvantageous in increasing the surface area of the electrode foil. For example, in the case of large pores, when two pores are formed close to each other, the pores crush each other, and the peripheral length of the pores (the total length of contours of inner wall surfaces of pores present per unit area of a cross section of the porous portion) tends to be shorter, hardly contributing to improving the capacity. When the V_{L1}/V₀ (further the V_{L2}/V₀) is within the above range, the large pores are few, and many pores having a pore size suitable for improving the capacity are distributed, easily leading to increased surface area of the electrode foil, and thus to high capacity.

In view of securing the strength and improving the capacity, a thickness T_{A} of the metal foil is, for example, 90 μm or more, preferably 110 μm or more, more preferably 120 μm or more. The thickness T_{A} of the metal foil may be 200 μm or less. A thickness T of the porous portion may be 25 μm or more and 90 μm or less, and may be 35 μm or more and 80 μm or less. When the thickness T_{A} of the metal foil is within the above range, the thickness T of the porous portion can be increased within the above range, while the thickness of the core portion is sufficiently secured. The thickness of the core portion, for example, may be 20 μm or more, and may be 25 μm or more.

When the thickness T_{A} of the metal foil is large (e.g., when it is within the above range), the stress generated in the metal foil (surface layer) in winding becomes great. Therefore, the effect of improving the strength of the surface layer (the effect of suppressing the occurrence of cracks due to the above stress) when the glossiness G₁ is 10 or more can be noticeably obtained.

The metal foil includes a valve metal. Examples of the valve metal include aluminum (Al), tantalum (Ta), and niobium (Nb). The metal foil may be a foil of a valve metal (e.g., Al), and may be a foil of an alloy or compound containing a valve metal (e.g., Al). When the metal foil is used as an anode foil, a dielectric layer may be formed so as to cover the metal skeleton constituting the porous portion. The dielectric layer is, for example, a layer containing an oxide of the valve metal.

Here, FIG. 1 is a schematic sectional view of an electrode foil for electrolytic capacitors according to one embodiment of the present disclosure. FIG. 1 shows a cross section in the thickness direction of the electrode foil. The electrode foil for electrolytic capacitors according to the present disclosure is not limited thereto.

The electrode foil (metal foil 300) contains a valve metal, and includes a core portion 330 and porous portions 310 and 320 continuous with the core portion 330. The metal foil 300 has a first principal surface S1, and a second principal surface S2 opposite to the first principal surface S1. The porous portion 310 and the porous portion 320 are formed, with a core portion 330 therebetween. The porous portion 310 has the principal surface S1 of the metal foil 300. The porous portion 320 has the principal surface S2 of the metal foil 300.

At least one of a first glossiness G₁₋₁ at an incidence angle of 20 degrees of the first principal surface S1 and a second glossiness G₁₋₂ at an incidence angle of 20 degrees of the second principal surface S2 is the glossiness G₁ of 10 or more. Preferably, both the first glossiness G₁₋₁ and the second glossiness G₁₋₂ are 10 or more. The first glossiness G₁₋₁ may be different from the second glossiness G₁₋₂. In the latter case, it is preferable to wind the metal foil such that, of the principal surfaces having the first glossiness G₁₋₁ and the second glossiness G₁₋₂, one having a higher glossiness faces the outer peripheral side of the wound body. In this case, the tensile stress generated in winding is greater in the principal surface on the outer peripheral side of the wound body. Therefore, the effect of improving the strength of the surface layer (the effect of suppressing the occurrence of cracks in winding) can be noticeably obtained.

The porous portion 310 has a thickness T (μm), and has an inner layer region 312 on the core portion 330 side and a surface layer region 311 on the opposite side to the core portion 330. The surface layer region 311 is a region within a distance of T/4 or less from an outer surface S of the porous portion 310. The inner layer region 312 is a region within a distance of T/4 or less from a boundary B between the porous portion 310 and the core portion 330. When the glossiness G₁₋₁ is 10 or less, an average size D₁ (nm) of pores in the surface layer region 311 can be smaller than an average size D₂ (nm) of pores in the inner layer region 312. The same applies to the porous portion 320 (a surface layer region 321 and an inner layer region 322).

### (Method of Producing Electrode Foil for Electrolytic Capacitors)

A method for producing an electrode foil for electrolytic capacitors includes an etching step of etching a sheet containing a valve metal, to form a porous portion on a principal surface of the sheet, and a compression step of compressing the etched sheet in the thickness direction, to form a sheet principal surface having a glossiness G₁ at an incidence angle of 20 degrees of 10 or more.

A sheet used for etching (hereinafter sometimes referred to as a “raw material sheet”) contains a valve metal. Examples of the valve metal include Al, Ta, and Nb. The raw material sheet may be a sheet of a valve metal (e.g., Al), and may be a sheet of an alloy or compound containing a valve metal (e.g., Al). The raw material sheet is usually a long length of or belt-shaped rolled sheet (rolled foil).

The etching forms a porous portion on the sheet principal surface, and the portion other than the porous portion remains as a core portion. That is, the etched sheet has a core portion, and a porous portion continuous with the core portion, and the porous portion has the sheet principal surface. The porous portion is usually formed on each of both principal surfaces of the sheet, such that the porous portions sandwich the core portion. In the compression step, the sheet having the porous portion formed by etching is compressed. The surface layer of the porous portion has low strength and is easily compressed in the compression step.

By performing the above compression step (by appropriately adjusting the thickness reduction percentage, etc.), the glossiness, D₁/D₂, P₁/P₂, V_{S1}/V₀, V_{S2}/V₀, V_{L1}/V₀, V_{L2}/V₀, etc. can be controlled within the aforementioned ranges.

In a production process of an electrolytic capacitor, the sheet comes in contact with a processing solution (e.g., an etching solution, a chemical conversion solution) and rollers, which can cause irregularities (or flaws) to be formed thereon. Stress may concentrate on the irregularities in the production process, causing the sheet to break (or causing cracks to occur in the sheet). Also, an Al raw foil or the like used for the sheet has rolling marks generated in its production process, and along the rolling marks, in other words, along the length direction (rolling direction) of the long sheet, etching pits can be nonuniformly formed. Due to the influence of the rolling marks, the sheet breaks (or cracks occur in the sheet) in some cases. Against this, as described above, by appropriately compressing the etched sheet, the aforementioned unfavorable effects of the irregularities and the rolling marks are reduced, the strength of the surface layer of the sheet is enhanced, and the breakage of the sheet is suppressed.

After the compression step, the thickness T_{A} of the sheet may be 90 μm or more and 200 μm or less, and may be 120 μm or more and 200 μm or less. After the compression step, the thickness T per one side the porous portion may be 25 μm or more and {(T_{A}/2)−10} μm or less. When the thickness T is within the above range, a sufficient thickness of the core portion can be ensured. The thickness T may be 25 μm or more and 90 μm or less, and may be 35 μm or more and 80 μm or less. With a high-capacity foil, in which the thickness T of the porous portion is large, the effect of improving the surface layer strength by compression can be noticeably obtained. Especially in a hybrid capacitor, a high-capacity foil is used, and the thickness T_{A} of the sheet (electrode foil) is preferably 90 μm or more, and the thickness T of the porous portion is preferably 25 μm or more.

### (Etching Step)

In the etching step, a surface of a sheet containing a valve metal is etched to roughen the surface of the sheet, to form a porous portion continuous with the core portion. The etching may be electrolytic etching or chemical etching, or may be performed using a known method.

In view of forming pores with large size, electrolytic etching may be performed at a current density of 2.0 A/cm² or less, may be performed a current density of 1.5 A/cm² or less, and may be performed at a current density of 1.2 A/cm² or less. The current density may be changed during etching. The larger the pore size is, the more likely a dielectric layer with large thickness is to be formed, which is advantageous in terms of achieving high voltage. Electrolytic etching is preferably AC etching, but may be DC etching. In the case of AC etching, a porous portion including sponge-like pits having a relatively small size is likely to be formed. In the case of DC etching, a porous portion including tunnel-like pits having a relatively large size is likely to be formed.

When the etching time is denoted by T_{E}, the temperature of the etching solution may be set to 10° C. or higher and 60° C. or lower between 0 and 0.7 T_{E}, and to 5° C. or higher and 40° C. or lower between 0.7 T_{E} and T_{E}. In this case, variations in pit sizes in the thickness direction of the porous portion can be reduced. The etching time T_{E} is 15 minutes or more and 30 minutes or less, for example.

### (Compression Step)

In the compression step, the etched sheet may be transported between a pair of rollers, to be compressed. The etched sheet transported between a pair of rollers is compressed by the pressing force of the pair of rollers. By appropriately adjusting the conditions of the roll press as described later, the glossiness, D₁/D₂ (further P₁/P₂), V_{S1}/V₀ (further V_{S2}/V₀), and V_{L1}/V₀ (further V_{L2}/V₀) can be easily controlled within the above ranges.

The pair of rollers may be arranged in a plurality of stages, to compress the sheet stepwise. In this case, the diameter of the pair of rollers may be changed for each stage, or may be reduced as the compression of the sheet proceeds. The compression step may include a step of transporting the sheet on a roller and a step of taking up the compressed sheet on a roller. The compression increases the strength of the surface layer of the sheet, and the breakage of the sheet that may occur when the sheet is taken up on the roller is suppressed.

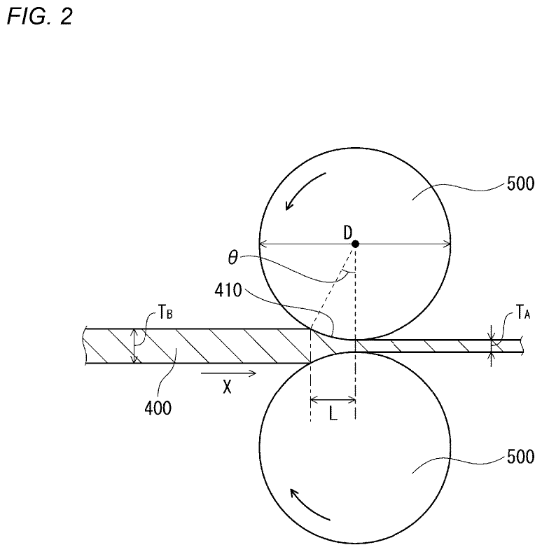

Here, FIG. 2 is a configuration diagram illustrating an example of the compression step. The reference sign X in FIG. 2 indicates the transport direction of a long sheet 400. In the compression step, for example, a compression apparatus shown in FIG. 2 is used. The compression apparatus includes a pair of rollers 500 that compress the sheet 400. The etched sheet 400 having a thickness T_{B} (mm) is compressed into a thickness T_{A} (mm) by the pressing force of the pair of rollers 500. The sheet delivery speed may be 0.5 m/min or more, and may be 0.5 m/min or more and 50 m/min or less.

In view of easily obtaining the above-described electrode foil, the thickness reduction percentage of the sheet in the compression step is preferably 5% or more and 40% or less, more preferably 10% or more and 30% or less, further more preferably 10% or more and 25% or less. The thickness reduction percentage is, given that the thickness of the sheet is reduced from T_{B} to T_{A} by the compression, a value calculated as {(T_{B}-T_{A})/T_{B}}×100.

When one of the rollers 500 is viewed from its rotation axis direction, a contact region 410 between the roller 500 and the sheet 400 has an arch shape, and a central angle θ of the roller 500 to the arc of the contact region 410 may be 0.15° or more and 1.5° or less (or 1.75° or less).

When a projection region is assumed to be a region obtained by projecting the contact region 410 between the sheet 400 and the roller 500 to a virtual plane parallel to the principal surface of the sheet 400, a length L of the projection region in the transport direction X of the sheet 400 may be 0.5 mm or more and 5 mm or less.

The sheet 400 may be compressed with a linear pressure of 0.55 kN/cm or more and 14 kN/cm or less. A diameter D of each of the rollers 500 may be 75 mm or more and 1800 mm or less. A thickness T₀ (mm) of each of the porous portions of the sheet 400 before compression and the diameter D (mm) of each of the rollers 500 may satisfy 380≤D/T₀≤9800.

The apparatus may further include a roller that transports the sheet 400, or a roller that takes up the compressed sheet 400. The apparatus may include a control unit configured to control the rotational speed of the rollers 500 and the like. The control unit may be configured to control the delivery speed of the sheet 400.

The method for producing an electrode foil may include a step of slitting the compressed sheet. In the slitting, a slitting apparatus, and a roller that takes up the slitted sheet are used. The compression increases the strength of the surface layer of the sheet, which suppresses the breakage of the sheet that may occur when the sheet is taken up on the roller.

### (Electrolytic Capacitor)

The electrode foil for electrolytic capacitors according to an embodiment of the present disclosure can be suitably used in an electrolytic capacitor including a wound capacitor element. The wound capacitor element includes a wound body and an electrolyte. The wound body includes an anode foil and a cathode foil wound together with a separator disposed between the anode foil and the cathode foil. The anode foil includes the above-described electrode foil according to an embodiment of the present disclosure (hereinafter sometimes referred to as the “electrode foil A”), and a dielectric layer covering a metal skeleton constituting the porous portion of the electrode foil A.

In an electrolytic capacitor having a rated voltage of 20 V or more, for example, an Al foil chemically converted with a chemical conversion voltage of 30 V or more is used as the anode foil. In an electrolytic capacitor including a solid electrolyte (conductive polymer) and an electrolyte solution, for example, an Al foil chemically converted with a chemical conversion voltage of 40 V or more is used as the anode foil, in many cases. For such an anode foil, an electrode foil having a relatively large pit size is used, on which a dielectric layer having a relatively large thickness (e.g., a thickness of 45 nm or more) is formed, and thus, the strength of the surface layer tends to be reduced. Therefore, the effect of improving the surface layer strength by the electrode foil A can be noticeably obtained. With a chemical conversion voltage of 30 V or more (or 40 V or more), a chemical conversion film to be produced will be thick. By using an electrode foil having a large pit size, the clogging of the pits due to the thick chemical conversion film can be suppressed, and high capacity can be efficiently achieved.

### (Anode Foil)

The anode foil includes the electrode foil A, and a dielectric layer covering the metal skeleton constituting the porous portion of the electrode foil A. The dielectric layer is obtained by forming an oxide film of a valve metal on the surface of the metal skeleton constituting the porous portion by, for example, anodization (chemical conversion treatment). When chemical conversion treatment is applied to an Al foil, the chemical formation voltage may be, for example, 5 V or more, or 40 V or more.

When the glossiness G₁ of the electrode foil A is 10 or more, a glossiness G₂ at an incidence angle of 20 degrees of the principal surface of the anode foil is 10 or more. The glossiness G₂ of the principal surface of the anode foil including the electrode foil A is approximately the same value as that of the glossiness G₁ of the principal surface of the electrode foil A.

The principal surface of the anode foil may have a first principal surface, and a second principal surface opposite to the first principal surface. The porous portion may include a first porous portion having a first principal surface and a second porous portion having a second principal surface, with the core portion therebetween. The dielectric layer may include a first dielectric layer covering the metal skeleton constituting the first porous portion, and a second dielectric layer covering the metal skeleton constituting the second porous portion. In this case, at least one of a first glossiness G₂₋₁ at an incidence angle of 20 degrees of the first principal surface and a second glossiness G₂₋₂ at an incidence angle of 20 degrees of the second principal surface is the glossiness G₂ of 10 or more. Preferably, both the first glossiness G₂₋₁ and the second glossiness G₂₋₂ are the glossiness G₂ of 10 or more. The first glossiness G₂₋₁ may be higher than the second glossiness G₂₋₂. In the latter case, in the wound body, the anode foil is preferably wound such that the first principal surface faces the outer peripheral side of the wound body. By disposing the anode foil such that the first principal surface having a higher glossiness (a higher surface layer strength) is positioned on the outer peripheral side of the wound body in which a large tensile stress will be generated in winding, the effect of suppressing the occurrence of cracks due to the stress generated in winding can be noticeably obtained.

The thickness of the anode foil may be 60 μm or more and 200 μm or less, may be 90 μm or more and 200 μm or less, and may be 120 μm or more and 200 μm or less. The thickness of the dielectric layer is, for example, 45 nm or more.

### (Cathode Foil)

The cathode foil may be a metal foil containing a valve metal, such as Al, Ta, or Nb. A surface of the metal foil may be roughened by etching, as necessary. That is, the cathode foil may be a metal foil having a porous portion, and a core portion continuous with the porous portion. The electrode foil for electrolytic capacitors according to the present disclosure may be used for the cathode foil. The thickness of the cathode foil is, for example, 10 μm or more and 70 μm or less.

### (Separator)

The separator is not particularly limited, and may be, for example, a non-woven fabric or the like containing fibers of cellulose, polyethylene terephthalate, vinylon, or polyamide (e.g., aliphatic polyamide, or aromatic polyamide such as aramid).

### (Electrolyte)

The electrolyte covers at least part of the anode foil (dielectric layer), and is interposed between the anode foil (dielectric layer) and the cathode foil. The electrolyte includes at least either one of a solid electrolyte and a liquid electrolyte. The capacitor element may include a solid electrolyte, and may include a solid electrolyte and a liquid component (an electrolyte solution or a nonaqueous solvent).

The covering of the dielectric layer with the electrolyte is done by, for example, impregnating a treatment solution containing a conductive polymer (or electrolyte solution) into the anode foil (or wound body). In the above electrode foil, in which the D₁ is smaller than D₂ (further, P₁ is smaller than P₂), the treatment solution impregnated into the porous portion is likely to stay in the pores, so that the inner walls of the pores are likely to be covered with the electrolyte, improving the contact between the anode foil (dielectric layer) and the electrolyte.

The solid electrolyte contains a conductive polymer. The conductive polymer may be, for example, a π-conjugated polymer. Examples of the conductive polymer include polypyrrole, polythiophene, polyfuran, and polyaniline. The conductive polymer may be used singly or in combination of two or more, or may be a copolymer of two or more monomers. The weight-average molecular weight of the conductive polymer is, for example, 1000 to 100000.

In the present specification, polypyrrole, polythiophene, polyfuran, polyaniline, and the like mean polymers having polypyrrole, polythiophene, polyfuran, polyaniline, and the like, respectively, as a basic skeleton. Therefore, polypyrrole, polythiophene, polyfuran, polyaniline, and the like can include derivatives thereof, too. For example, polythiophene includes poly(3,4-ethylenedioxythiophene) and the like.

The conductive polymer can be doped with a dopant. The solid electrolyte may contain a dopant together with the conductive polymer. The dopant includes polystyrene sulfonic acid and the like. The solid electrolyte may further contain an additive, as necessary.

The liquid component may be an electrolyte solution, and may be a nonaqueous solvent. The electrolyte solution contains a nonaqueous solvent and an ionic substance (solute (e.g., organic salt)) dissolved therein. The nonaqueous solvent may be an organic solvent, and may be an ionic liquid.

As the nonaqueous solvent, a solvent with high-boiling point is preferred. For example, a polyol compound such as ethylene glycol, a sulfone compound such as sulfolane, a lactone compound such as γ-butyrolactone, an ester compound such as methyl acetate, a carbonate compound such as propylene carbonate, an ether compound such as 1,4-dioxane, a ketone compound such as methyl ethyl ketone, and the like can be used.

The liquid component may include an acid component (anion) and a base component (cation). The acid component and the base component may form a salt (solute). The acid component contributes to the film repair function. Examples of the acid component include an organic carboxylic acid, and an inorganic acid. The inorganic acid may be, for example, phosphoric acid, boric acid, sulfuric acid, and the like. Examples of the base component include primary to tertiary amine compounds.

An organic salt is a salt in which at least one of the anion and the cation contains an organic substance. As the organic salt, for example, trimethylamine maleate, triethylamine borodisalicylate, ethyldimethylamine phthalate, mono 1,2,3,4-tetramethylimidazolinium phthalate, mono 1,3-dimethyl-2-ethylimidazolinium phthalate, and the like can be used.

In view of suppressing de-doping of the dopant from the conductive polymer (degradation of the solid electrolyte), it is preferable that the acid component is contained in the liquid component in an amount larger than the base component. Also, considering that the acid component contributes to the film repair function by the liquid component, it is preferable that the acid component is contained in an amount larger than the base component. The molar ratio (acid component/base component) of the acid component to the base component is, for example, 1.1 or more. In view of the suppression of the de-doping of the dopant from the conductive polymer, and the like, the pH of the liquid component may be 6 or less, and may be 1 or more and 5 or less.

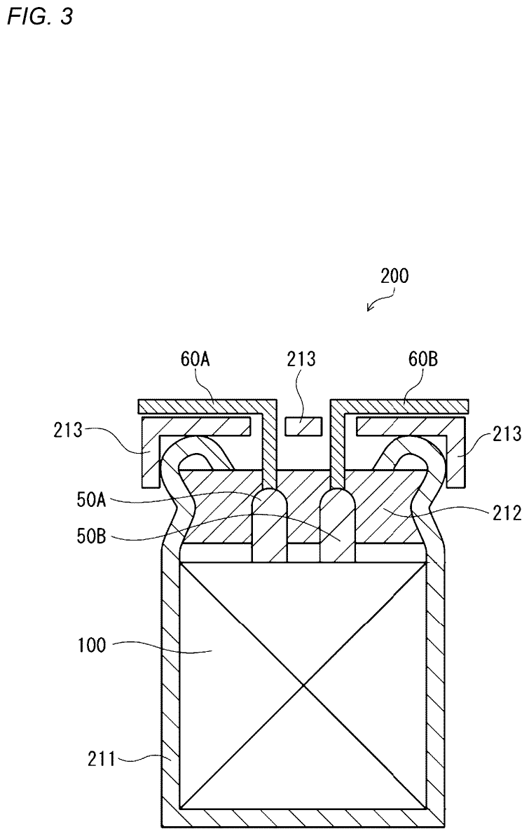

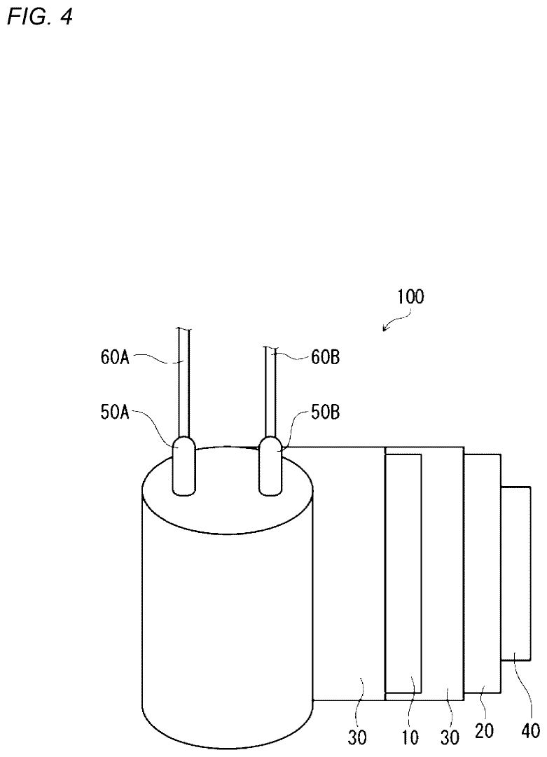

Here, FIG. 3 is a schematic sectional view illustrating an example of an electrolytic capacitor according to one embodiment of the present disclosure. FIG. 4 is a schematic oblique view illustrating the configuration of a wound body of FIG. 3.

An electrolytic capacitor 200 includes a capacitor element, and the capacitor element includes a wound body 100 and an electrolyte (not shown). The wound body 100 is constituted by winding an anode foil 10 and a cathode foil 20, with a separator 30 interposed therebetween.

The anode foil 10 and the cathode foil 20, to which one ends of lead tabs 50A and 50B are connected respectively, are wound together with the lead tabs 50A and 50B, constituting the wound body 100. To the other ends of the lead tabs 50A and 50B, lead wires 60A and 60B are connected respectively.

On the outer surface of the cathode foil 20 positioned on the outermost layer of the wound body 100, a winding stop tape 40 is disposed, and the end of the cathode foil 20 is secured by the winding stop tape 40. In the case of preparing the anode foil 10 by cutting out from a large-size foil, the wound body 100 may be further subjected to a chemical conversion treatment in order to provide the cut surfaces with a dielectric layer.

An electrolyte is present between the anode foil 10 (dielectric layer) and the cathode foil 20 in the wound body 100. The capacitor element can be obtained by, for example, impregnating a treatment solution containing an electrolyte into the wound body 100. The impregnation may be performed under reduced pressure, for example, in an atmosphere of 10 kPa to 100 kPa.

The wound body 100 is housed in a bottomed case 211, such that the lead wires 60A and 60B are positioned on the opening side of the bottomed case 211. As the material of the bottomed case 211, a metal, such as aluminum, stainless steel, copper, iron, and brass, or an alloy thereof can be used.

With a sealing member 212 disposed at the opening of the bottomed case 211 which houses the wound body 100 and the electrolyte, the opening end of the bottomed case 211 is curled to be crimped onto the sealing member 212, and a seat plate 213 is disposed on the curled portion. Thus, the wound body 100 is sealed within the bottomed case 211.

The sealing member 212 is formed such that the lead wires 60A and 60B can penetrate therethrough. The sealing member 212 may be any insulating material, and an elastic body is preferred. In particular, silicone rubber, fluorine rubber, ethylene-propylene rubber, Hypalon rubber, butyl rubber, isoprene rubber, and others with excellent heat resistance are preferred.

The electrode foil according to an embodiment of the present disclosure can be used for an electrolytic capacitor including the aforementioned wound capacitor element, and may also be used in an electrolytic capacitor including a stacked capacitor element. In the latter case, the porous portion is formed in a partial region of the electrode foil surface. The stacked capacitor element includes an anode body, a solid electrolyte layer, and a cathode-leading layer covering the solid electrolyte layer. The anode body includes the above electrode foil with the porous portion formed on a part of the surface, and a dielectric layer covering the metal skeleton constituting the porous portion of the electrode foil. The solid electrolyte layer is formed so as to cover the dielectric layer. The cathode-leading layer includes, for example, a silver paste layer and a carbon layer. An anode lead is connected to a region of the anode body not covered with the dielectric layer, and a cathode lead is connected to the cathode-leading layer.

### <<Supplementary Notes>>

The above description of embodiments discloses the following techniques.

### (Technique 1)

An electrode foil for electrolytic capacitors, comprising
a metal foil containing a valve metal, wherein
the metal foil includes a core portion, and a porous portion continuous with the core portion,
the porous portion has a principal surface of the metal foil, and
the principal surface has a glossiness G₁ at an incidence angle of 20 degrees of 10 or more.

### (Technique 2)

The electrode foil for electrolytic capacitors according to technique 1, wherein the glossiness G₁ is 10 or more and 140 or less.

### (Technique 3)

The electrode foil for electrolytic capacitors according to technique 1 or 2, wherein the metal foil contains Al.

### (Technique 4)

The electrode foil for electrolytic capacitors according to any one of techniques 1 to 3, wherein the glossiness G₁ is measured by making light incident on the principal surface, in parallel to a length direction of the metal foil with long length when viewed from a direction normal to the principal surface.

### (Technique 5)

The electrode foil for electrolytic capacitors according to any one of techniques 1 to 4, wherein
the porous portion has a thickness T, and includes an inner layer region on the core portion side, and a surface layer region on an opposite side to the core portion,
the surface layer region is a region within a distance T/4 or less from an outer surface of the porous portion,
the inner layer region is a region within a distance T/4 or less from a boundary between the porous portion and the core portion, and
an average size D₁ of pores in the surface layer region is smaller than an average size D₂ of pores in the inner layer region.

### (Technique 6)

The electrode foil for electrolytic capacitors according to technique 5, wherein a ratio D₁/D₂ of the D₁ to the D₂ is 0.5 or more and 0.98 or less.

### (Technique 7)

The electrode foil for electrolytic capacitors according to technique 5 or 6, wherein a porosity P₁ of the surface layer region is smaller than a porosity P₂ of the inner layer region.

### (Technique 8)

The electrode foil for electrolytic capacitors according to technique 7, wherein a ratio P₁/P₂ of the P₁ to the P₂ is 0.5 or more and 0.95 or less.

### (Technique 9)

The electrode foil for electrolytic capacitors according to any one of techniques 1 to 8, wherein a surface roughness Ra of the metal foil is 1.5 μm or less.

### (Technique 10)

The electrode foil for electrolytic capacitors according to any one of techniques 1 to 9, wherein
in a pore distribution of the porous portion as measured by mercury intrusion porosimetry,
V_{S1}/V₀≤0.07 is satisfied, where
the V₀ is a cumulative pore volume (cm³/g) for pore sizes of 0.01 μm or more and 1 μm or less, and
the V_{S1} is a cumulative pore volume (cm³/g) for pore sizes of 0.01 μm or more and 0.06 μm or less.

### (Technique 11)

The electrode foil for electrolytic capacitors according to any one of techniques 1 to 10, wherein
in a pore distribution of the porous portion as measured by mercury intrusion porosimetry,
V_{L1}/V₀≤0.4 is satisfied, where
the V₀ is a cumulative pore volume (cm³/g) for pore sizes of 0.01 μm or more and 1 μm or less, and
the V_{L1} is a cumulative pore volume (cm³/g) for pore sizes of 0.16 μm or more and 1 μm or less.

### (Technique 12)

The electrode foil for electrolytic capacitors according to any one of techniques 1 to 11, wherein a thickness T_{A} of the metal foil is 90 μm or more and 200 μm or less.

### (Technique 13)

The electrode foil for electrolytic capacitors according to any one of techniques 1 to 12, wherein a thickness T of the porous portion is 25 μm or more and 90 μm or less.

### (Technique 14)

The electrode foil for electrolytic capacitors according to any one of techniques 1 to 13, wherein
the principal surface of the metal foil includes a first principal surface and a second principal surface opposite to the first principal surface,
the porous portion includes a first porous portion having the first principal surface, and a second porous portion having the second principal surface, with the core portion between the first porous portion and the second porous portion, and
at least one of a first glossiness G₁₋₁ at an incidence angle of 20 degrees of the first principal surface and a second glossiness G₁₋₂ at an incidence angle of 20 degrees of the second principal surface is the glossiness G₁.

### (Technique 15)

The electrode foil for electrolytic capacitors according to technique 14, wherein the first glossiness G₁₋₁ is different from the second glossiness G₁₋₂.

### (Technique 16)

An electrolytic capacitor, comprising
a capacitor element, wherein
the capacitor element includes a wound body and an electrolyte,
the wound body includes an anode foil and a cathode foil wound together with a separator disposed between the anode foil and the cathode foil, and
the anode foil includes the electrode foil according to technique 1, and a dielectric layer covering a metal skeleton constituting the porous portion of the electrode foil.

### (Technique 17)

The electrolytic capacitor according to technique 16, wherein a thickness of the dielectric layer is 45 nm or more.

### (Technique 18)

The electrolytic capacitor according to technique 16 or 17, wherein
the capacitor element contains a solid electrolyte as the electrolyte, and may further contain a liquid component, and
the solid electrolyte contains a conductive polymer.

### (Technique 19)

The electrolytic capacitor according to any one of techniques 16 to 18, wherein a principal surface of the anode foil has a glossiness G₂ at an incidence angle of 20 degrees of 10 or more.

### (Technique 20)

The electrolytic capacitor according to technique 19, wherein
the principal surface of the anode foil includes a first principal surface, and a second principal surface opposite to the first principal surface,
the porous portion includes a first porous portion having the first principal surface, and a second porous portion having the second principal surface, with the core portion between the first porous portion and the second porous portion,
the dielectric layer includes a first dielectric layer covering a metal skeleton constituting the first porous portion, and a second dielectric layer covering a metal skeleton constituting the second porous portion, and
at least one of a first glossiness G₂₋₁ at an incidence angle of 20 degrees of the first principal surface and a second glossiness G₂₋₂ at an incidence angle of 20 degrees of the second principal surface is the glossiness G₂.

### (Technique 21)

The electrolytic capacitor according to technique 20, wherein
the first glossiness G₂₋₁ is higher than the second glossiness G₂₋₂, and
in the wound body, the anode foil is wound with the first principal surface facing an outer periphery of the wound body.

### (Technique 22)

A method for producing an electrode foil for electrolytic capacitors, comprising:
an etching step of etching a sheet containing a valve metal, to form porous portions on both principal surfaces of the sheet, and
a step of compressing the etched sheet in a thickness direction, to provide the principal surfaces with a glossiness G₁ at an incidence angle of 20 degrees of 10 or more.

### (Technique 23)

The method for producing an electrode foil for electrolytic capacitors according to technique 22, wherein the glossiness G₁ is 10 or more and 140 or less.

### (Technique 24)

The method for producing an electrode foil for electrolytic capacitors according to technique 22 or 23, wherein the sheet contains Al.

### (Technique 25)

The method for producing an electrode foil for electrolytic capacitors according to any one of techniques 22 to 24, wherein, after the compression step,
90≤T_{A}≤200, and 25≤T≤(T_{A}/2)−10 are satisfied, where
the T_{A} is a thickness (μm) of the sheet, and the Tis a thickness (μm) per side of the porous portions.

### (Technique 26)

The method for producing an electrode foil for electrolytic capacitors according to any one of techniques 22 to 25, wherein the etching step is performed at a current density of 2.0 A/cm² or less.

### (Technique 27)

The method for producing an electrode foil for electrolytic capacitors according to any one of techniques 22 to 26, wherein in the compression step, a thickness of the sheet is reduced by 5% or more and 40% or less.

### (Technique 28)

The method for producing an electrode foil for electrolytic capacitors according to any one of techniques 22 to 27, wherein in the compression step, the sheet is transported between a pair of rollers, to be compressed.

### (Technique 29)

The method for producing an electrode foil for electrolytic capacitors according to technique 28, wherein a delivery speed of the sheet is 0.5 m/min or more.

### (Technique 30)

The method for producing an electrode foil for electrolytic capacitors according to technique 28 or 29, wherein
when one of the rollers is viewed from a rotation axis direction of the roller, a contact region between the roller and the sheet is arc-shaped, and
a central angle θ of the roller with respect to an arc of the contact region is 0.15° or more and 1.5° or less.

### (Technique 31)

The method for producing an electrode foil for electrolytic capacitors according to any one of techniques 28 to 30, wherein
when a projection region is assumed to be a region obtained by projecting a contact region between the sheet and one of the rollers onto a virtual plane parallel to the principal surfaces of the sheet,
a length L of the projection region in a transport direction of the sheet is 0.5 mm or more and 5 mm or less.

### (Technique 32)

The method for producing an electrode foil for electrolytic capacitors according to any one of techniques 22 to 31, wherein the sheet is compressed at a linear pressure of 0.55 kN/cm or more and 14 kN/cm or less.

### (Technique 33)

The method for producing an electrode foil for electrolytic capacitors according to any one of techniques 22 to 32, wherein a thickness T₀ (mm) of the porous portion of the sheet before compression and a diameter D (mm) of the roller satisfy 380≤D/T₀≤9800.

### EXAMPLES

The present disclosure will be more specifically described below with reference to Examples. The present disclosure, however, is not limited to the following Example.

### Examples 1 and 2

### (Etching Step)

A foil-shaped Al sheet (thickness T_{B}: 130 μm) was etched, to form porous portions (thickness T₀ per side: 30 μm) on both sides of the Al sheet. In the etching, AC etching is performed, and the current density was appropriately adjusted within the range of 1.5 A/cm² or less. The etching time was also adjusted appropriately so as to obtain a desired amount of dissolution.

### (Compression Step)

The etched Al sheet was compressed in its thickness direction, to obtain electrode foils a1 and a2. In the compression step, the thickness of the sheet was reduced by a percentage (reduction percentage) as shown in Table 1. The sheet thickness T_{A} (μm) and the thickness T (μm) per side of the porous portion were set to the values as shown in Table 2.

As illustrated in FIG. 2, in the compression step, the Al sheet was transported between a pair of rollers (diameter D: 75 mm), to be compressed. The pressing force and the linear pressure of the rollers were set to the values as shown in Table 1. The delivery speed of the Al sheet was set to the values as shown in Table 1. The ratio D/To of the diameter D (mm) of the roller to the thickness T₀ (mm) of the porous portion of the sheet before compression was 2500. The angle θ in FIG. 2 was set to the values as shown in Table 1. The length L in FIG. 2 was set to the values as shown in Table 1.

TABLE 1

| | compression step | | | | | |
|---|---|---|---|---|---|---|
| | | | | thickness | | |
| | roller | roller | delivery | reduction | angle | length |
| | pressing | linear | speed of | percentage | θ in | L in |
| | force | pressure | Al sheet | of Al sheet | FIG. 2 | FIG. 2 |
| | (kN/50 cm) | (kN/cm) | (m/min) | (%) | (°) | (mm) |
| Com. | — | — | — | — | — | — |
| Ex. 1 | | | | | | |
| Ex. 1 | 34 | 0.67 | 1 | 7.7 | 0.94 | 0.61 |
| Ex. 2 | 44 | 0.88 | 1 | 11.5 | 1.15 | 0.75 |

The glossiness G₁, D₁/D₂, and P₁/P₂ determined by the already-described methods were the values as shown in Table 2. The arithmetic mean roughness Ra of the electrode foil was the values as shown in Table 2. The V_{S1}/V₀, V_{S2}/V₀, V_{L1}/V₀, and V_{L2}/V₀ determined by the already-described methods were the values as shown in Table 2. In the electrode foils a1 and a2, the glossiness Gₛ(60°) was 60 or more, and the glossiness Gₛ(85°) was 85 or more.

TABLE 2

| | | electrode foil | | | | | | | | | | |
|---|---|---|---|---|---|---|---|---|---|---|---|---|
| | | | arithmetic | porous portion of electrode foil | | | | | | | | |
| | | | mean | | glossiness | | | | | | | tensile |
| | | thick- | roughness | thick- | G₁ of | | | | | | | strength |
| | electrode | ness T_{A} | Ra | ness T | principal | | | | | | | (relative |
| | foil No. | (μm) | (μm) | (μm) | surface | D₁/D₂ | P₁/P₂ | V_{S1}/V₀ | V_{S2}/V₀ | V_{L1}/V₀ | V_{L2}/V₀ | value) |
| Com. Ex. 1 | b1 | 130 | 1.7 | 50 | 5.8 | 1.33 | 1.2 | 0.09 | 0.06 | 0.42 | 0.11 | 100 |
| Ex. 1 | a1 | 120 | 1.5 | 38 | 53.9 | 0.95 | 0.95 | 0.07 | 0.04 | 0.40 | 0.08 | 107 |
| Ex. 2 | a2 | 115 | 1.3 | 35 | 48.1 | 0.51 | 0.05 | 0.04 | 0.02 | 0.07 | 0.05 | 109 |

### (Formation of Dielectric Layer)

The electrode foils a1 and a2 were subjected to a chemical conversion treatment, to form a dielectric layer covering the metal skeleton constituting the porous portion. The chemical conversion treatment was performed with a chemical conversion voltage of 65 V, in accordance with the test method for electrode foil for aluminum electrolytic capacitors (EIAJ RC-2364A) of the Electronic Machinery Industry Standards of Japan. In this way, anode foils A1 and A2 were produced. The glossiness G₂ of the anode foils A1 to A2 determined by the already-described method was the values as shown in Table 3.

The electrode foils a1 and a2 are of Examples 1 and 2, and the anode foils A1 and A2 are chemically converted products of the electrode foils a1 and a2.

### Comparative Example 1

An electrode foil b1 was produced in the same manner as the electrode foil a1, except that the etched A1 sheet was not compressed. An anode foil B1 was produced in the same manner as the anode foil A1, except that the electrode foil b1 was used instead of the electrode foil a1. The glossiness G₂ of the anode foil B1 determined by the already-described method was the value as shown in Table 3.

### (Evaluation 1: Tensile Strength of Electrode Foil)

For each of the electrode foils, a belt-shaped sample (length direction 70 mm, width direction 10 mm) was prepared, and the tensile strength of the sample in the length direction was measured, in accordance with the test method for electrode foil for aluminum electrolytic capacitors (EIAJ RC-2364A) of the Electronic Machinery Industry Standards of Japan. The measurement results are shown in Table 1. In Table 2, the tensile strength is shown as a relative value, with the tensile strength of the electrode foil b1 taken as 100.

### (Evaluation 2: Capacity of Anode Foil)

For each of the anode foils, the capacitance was measured in accordance with the test method for electrode foil for aluminum electrolytic capacitors (EIAJ RC-2364A) of the Electronic Machinery Industry Standards of Japan. The measurement results are shown in Table 3. In Table 3, the capacitance is shown as a relative value, with the capacitance of the anode foil B1 taken as 100. Table 3 also shows the capacity per unit volume of the anode foil.

TABLE 3

| | | | capacity per unit |
|---|---|---|---|
| | glossiness G₂ of | capacitance | volume |
| anode foil | principal surface | (relative value) | (relative value) |
| B1 | 5.8 | 100 | 100 |
| A1 | 53.9 | 99.4 | 108 |
| A2 | 48.1 | 99.0 | 112 |

In the electrode foils a1 and a2, a higher tensile strength than the electrode foil b1 was obtained. In the anode foils A1 and A2, a favorable capacity was obtained, and the capacity per unit volume was high.

### Examples 3 to 5

### (Etching Step)

A foil-shaped Al sheet (thickness T_{B}: 150 μm) was etched, to form porous portions (thickness T₀ per side: 60 μm) on both sides of the Al sheet. In the etching, AC etching was performed, and the current density was appropriately adjusted within the range of 1.5 A/cm² or less. The etching time was also adjusted appropriately so as to obtain a desired amount of dissolution.

### (Compression Step)

The etched Al sheet was compressed in its thickness direction, to obtain electrode foils a3 to a5. In the compression step, the thickness of the sheet was reduced by a percentage (reduction percentage) as shown in Table 4. The sheet thickness T_{A} (μm) and the thickness T (μm) per side of the porous portion were set to the values as shown in Table 5.

As illustrated in FIG. 2, in the compression step, the Al sheet was transported between a pair of rollers (diameter D: 75 mm), to be compressed. The pressing force and the linear pressure of the rollers were set to the values as shown in Table 4. The delivery speed of the Al sheet was set to the values as shown in Table 4. The ratio D/T₀ of the diameter D (mm) of the roller to the thickness T₀ (mm) of the porous portion of the sheet before compression was 1250. The angle θ in FIG. 2 was set to the values as shown in Table 4. The length L in FIG. 2 was set to the values as shown in Table 4.

TABLE 4

| | compression step | | | | | |
|---|---|---|---|---|---|---|
| | | | | thickness | | |
| | roller | roller | delivery | reduction | angle | length |
| | pressing | linear | speed of | percentage | θ in | L in |
| | force | pressure | Al sheet | of Al sheet | FIG. 2 | FIG. 2 |
| | (kN/50 cm) | (kN/cm) | (m/min) | (%) | (°) | (mm) |
| Com. | — | — | — | — | — | — |
| Ex. 2 | | | | | | |
| Ex. 3 | 29 | 0.59 | 1 | 6.7 | 0.94 | 0.61 |
| Ex. 4 | 43 | 0.87 | 1 | 13.3 | 1.32 | 0.87 |
| Ex. 5 | 64 | 1.29 | 1 | 23.3 | 1.75 | 1.15 |

The glossiness G₁, D₁/D₂, and P₁/P₂ determined by the already-described methods were the values as shown in Table 5. The arithmetic mean roughness Ra of the electrode foil was the values as shown in Table 5. The V_{S1}/V₀, V_{S2}/V₀, V_{L1}/V₀, and V_{L2}/V₀ determined by the already-described methods were the values as shown in Table 5. In the electrode foils a3 to a5, the glossiness Gₛ(60°) was 60 or more, and the glossiness Gₛ(85°) was 85 or more.

TABLE 5

| | | electrode foil | | | | | | | | | | |
|---|---|---|---|---|---|---|---|---|---|---|---|---|
| | | | arithmetic | porous portion of electrode foil | | | | | | | | |
| | | | mean | | glossiness | | | | | | | tensile |
| | | thick- | roughness | thick- | G₁ of | | | | | | | strength |
| | electrode | ness T_{A} | Ra | ness T | principal | | | | | | | (relative |
| | foil No. | (μm) | (μm) | (μm) | surface | D₁/D₂ | P₁/P₂ | V_{S1}/V₀ | V_{S2}/V₀ | V_{L1}/V₀ | V_{L2}/V₀ | value) |
| Com. Ex. 2 | b2 | 150 | 1.7 | 60 | 5.0 | 1.34 | 1.19 | 0.09 | 0.07 | 0.43 | 0.11 | 100 |
| Ex. 3 | a3 | 140 | 1.6 | 40 | 67.1 | 0.96 | 0.95 | 0.07 | 0.04 | 0.40 | 0.08 | 108 |
| Ex. 4 | a4 | 130 | 1.4 | 38 | 65.6 | 0.77 | 0.05 | 0.05 | 0.03 | 0.20 | 0.06 | 113 |
| Ex. 5 | a5 | 115 | 1.3 | 31 | 79.2 | 0.51 | 0.04 | 0.04 | 0.02 | 0.06 | 0.04 | 119 |

### (Formation of Dielectric Layer)

The electrode foils a3 to a5 were subjected to a chemical conversion treatment to form a dielectric layer covering the metal skeleton constituting the porous portion. The chemical conversion treatment was performed with a chemical conversion voltage of 65 V, in accordance with the test method for electrode foil for aluminum electrolytic capacitors (EIAJ RC-2364A) of the Electronic Machinery Industry Standards of Japan. In this way, anode foils A3 to A5 were produced. The glossiness G₂ of the anode foils A3 to A5 determined by the already-described method was the values as shown in Table 6.

The electrode foils a3 to a5 are of Examples 3 to 5, and the anode foils A3 to A5 are chemically converted products of the electrode foils a3 to a5.

### Comparative Example 2

An electrode foil b2 was produced in the same manner as the electrode foil a3, except that the etched Al sheet was not compressed. An anode foil B2 was produced in the same manner as the anode foil A3, except that the electrode foil b2 was used instead of the electrode foil a3. The glossiness G₂ of the anode foil B2 determined by the already-described method was the value as shown in Table 6.

The above evaluation 1 was performed on the electrode foils a3 to a5, and b2. The evaluation results are shown in Table 5. In Table 5, the tensile strength is shown as a relative value, with the tensile strength of the electrode foil b2 taken as 100. The above evaluation 2 was performed on the anode foils A3 to A5, and B2. The evaluation results are shown in Table 6. In Table 6, the capacitance is shown as a relative value, with the capacitance of the anode foil B2 taken as 100. Table 6 also shows the capacity per unit volume of the anode foil.

TABLE 6

| | | | capacity per unit |
|---|---|---|---|
| | glossiness G₂ of | capacitance | volume |
| anode foil | principal surface | (relative value) | (relative value) |
| B2 | 5.0 | 100 | 100 |
| A3 | 67.2 | 99.5 | 107 |
| A4 | 65.8 | 99.4 | 115 |
| A5 | 79.9 | 98.4 | 128 |

In the electrode foils a3 to a5, a higher tensile strength than the electrode foil b2 was obtained. In the anode foils A3 to A5, a favorable capacity was obtained, and the capacity per unit volume was high.

### INDUSTRIAL APPLICABILITY

The electrode foil according to the present disclosure can be suitably used in an electrolytic capacitor for which high reliability and high capacity are required.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10: anode foil, 20: cathode foil, 30: separator, 40: winding stop tape, 50A, 50B: lead tab, 60A, 60B: lead wire, 100, 400: winding body, 200: electrolytic capacitor, 211: bottomed case, 212: sealing member, 213: seat plate, 300: electrode foil, 310, 320: porous portion, 311: surface layer region, 312: inner layer region, 330: core portion, 400: sheet, 410: contact region, 500: roller

1. An electrode foil for electrolytic capacitors, comprising
a metal foil containing a valve metal, wherein
the metal foil includes a core portion, and a porous portion continuous with the core portion,
the porous portion has a principal surface of the metal foil, and
the principal surface has a glossiness G₁ at an incidence angle of 20 degrees of 10 or more.

2. The electrode foil for electrolytic capacitors according to claim 1, wherein the glossiness G₁ is 10 or more and 140 or less.

3. The electrode foil for electrolytic capacitors according to claim 1, wherein the metal foil contains Al.

4. The electrode foil for electrolytic capacitors according to claim 1, wherein the glossiness G₁ is measured by making light incident on the principal surface, in parallel to a length direction of the metal foil with long length when viewed from a direction normal to the principal surface.

5. The electrode foil for electrolytic capacitors according to claim 1, wherein
the porous portion has a thickness T, and includes an inner layer region on the core portion side, and a surface layer region on an opposite side to the core portion,
the surface layer region is a region within a distance T/4 or less from an outer surface of the porous portion,
the inner layer region is a region within a distance T/4 or less from a boundary between the porous portion and the core portion, and
an average size D₁ of pores in the surface layer region is smaller than an average size D₂ of pores in the inner layer region.

6. The electrode foil for electrolytic capacitors according to claim 5, wherein a ratio D₁/D₂ of the D₁ to the D₂ is 0.5 or more and 0.98 or less.

7. The electrode foil for electrolytic capacitors according to claim 5, wherein a porosity P₁ of the surface layer region is smaller than a porosity P₂ of the inner layer region.

8. The electrode foil for electrolytic capacitors according to claim 7, wherein a ratio P₁/P₂ of the P₁ to the P₂ is 0.5 or more and 0.95 or less.

9. The electrode foil for electrolytic capacitors according to claim 1, wherein a surface roughness Ra of the metal foil is 1.5 μm or less.

10. The electrode foil for electrolytic capacitors according to claim 1, wherein
in a pore distribution of the porous portion as measured by mercury intrusion porosimetry,
V_{S1}/V₀≤0.07 is satisfied, where
the V₀ is a cumulative pore volume (cm³/g) for pore sizes of 0.01 μm or more and 1 μm or less, and
the V_{S1} is a cumulative pore volume (cm³/g) for pore sizes of 0.01 μm or more and 0.06 μm or less.

11. The electrode foil for electrolytic capacitors according to claim 1, wherein
in a pore distribution of the porous portion as measured by mercury intrusion porosimetry,
V_{L1}/V₀≤0.4 is satisfied, where
the V₀ is a cumulative pore volume (cm³/g) for pore sizes of 0.01 μm or more and 1 μm or less, and
the V_{L1} is a cumulative pore volume (cm³/g) for pore sizes of 0.16 μm or more and 1 μm or less.

12. The electrode foil for electrolytic capacitors according to claim 1, wherein a thickness T_{A} of the metal foil is 90 μm or more and 200 μm or less.

13. The electrode foil for electrolytic capacitors according to claim 1, wherein a thickness T of the porous portion is 25 μm or more and 90 μm or less.

14. The electrode foil for electrolytic capacitors according to claim 1, wherein
the principal surface of the metal foil includes a first principal surface and a second principal surface opposite to the first principal surface,
the porous portion includes a first porous portion having the first principal surface, and a second porous portion having the second principal surface, with the core portion between the first porous portion and the second porous portion, and
at least one of a first glossiness at an incidence angle of 20 degrees G₁₋₁ of the first principal surface and a second glossiness G₁₋₂ at an incidence angle of 20 degrees of the second principal surface is the glossiness G₁.

15. The electrode foil for electrolytic capacitors according to claim 14, wherein the first glossiness G₁₋₁ is different from the second glossiness G₁₋₂.

16. An electrolytic capacitor, comprising
a capacitor element, wherein
the capacitor element includes a wound body and an electrolyte,
the wound body includes an anode foil and a cathode foil wound together with a separator disposed between the anode foil and the cathode foil, and
the anode foil includes the electrode foil according to claim 1, and a dielectric layer covering a metal skeleton constituting the porous portion of the electrode foil.

17. The electrolytic capacitor according to claim 16, wherein a thickness of the dielectric layer is 45 nm or more.

18. The electrolytic capacitor according to claim 16, wherein
the capacitor element contains a solid electrolyte as the electrolyte, and may further contain a liquid component, and
the solid electrolyte contains a conductive polymer.

19. The electrolytic capacitor according to claim 16, wherein a principal surface of the anode foil has a glossiness G₂ at an incidence angle of 20 degrees of 10 or more.

20. The electrolytic capacitor according to claim 19, wherein
the principal surface of the anode foil includes a first principal surface, and a second principal surface opposite to the first principal surface,
the porous portion includes a first porous portion having the first principal surface, and a second porous portion having the second principal surface, with the core portion between the first porous portion and the second porous portion,
the dielectric layer includes a first dielectric layer covering a metal skeleton constituting the first porous portion, and a second dielectric layer covering a metal skeleton constituting the second porous portion, and
at least one of a first glossiness G₂₋₁ at an incidence angle of 20 degrees of the first principal surface and a second glossiness G₂₋₂ at an incidence angle of 20 degrees of the second principal surface is the glossiness G₂.

21. The electrolytic capacitor according to claim 20, wherein
the first glossiness G₂₋₁ is higher than the second glossiness G₂₋₂, and
in the wound body, the anode foil is wound with the first principal surface facing an outer periphery of the wound body.

22. A method for producing an electrode foil for electrolytic capacitors, comprising:
an etching step of etching a sheet containing a valve metal, to form porous portions on both principal surfaces of the sheet, and
a step of compressing the etched sheet in a thickness direction, to provide the principal surfaces with a glossiness G₁ at an incidence angle of 20 degrees of 10 or more.

23. The method for producing an electrode foil for electrolytic capacitors according to claim 22, wherein the glossiness G₁ is 10 or more and 140 or less.

24. The method for producing an electrode foil for electrolytic capacitors according to claim 22, wherein the sheet contains Al.

25. The method for producing an electrode foil for electrolytic capacitors according to claim 22, wherein, after the compression step,
90≤T_{A}≤200, and 25≤T≤(T_{A}/2X)−10 are satisfied, where
the T_{A} is a thickness (μm) of the sheet, and the T is a thickness (μm) per side of the porous portions.

26. The method for producing an electrode foil for electrolytic capacitors according to claim 22, wherein the etching step is performed at a current density of 2.0 A/cm² or less.

27. The method for producing an electrode foil for electrolytic capacitors according to claim 22, wherein in the compression step, a thickness of the sheet is reduced by 5% or more and 40% or less.

28. The method for producing an electrode foil for electrolytic capacitors according to claim 22, wherein in the compression step, the sheet is transported between a pair of rollers, to be compressed.

29. The method for producing an electrode foil for electrolytic capacitors according to claim 28, wherein a delivery speed of the sheet is 0.5 m/min or more.

30. The method for producing an electrode foil for electrolytic capacitors according to claim 28, wherein
when one of the rollers is viewed from a rotation axis direction of the roller, a contact region between the roller and the sheet is arc-shaped, and
a central angle θ of the roller with respect to an arc of the contact region is 0.15° or more and 1.5° or less.

31. The method for producing an electrode foil for electrolytic capacitors according to claim 28, wherein
when a projection region is assumed to be a region obtained by projecting a contact region between the sheet and one of the rollers onto a virtual plane parallel to the principal surfaces of the sheet,
a length L of the projection region in a transport direction of the sheet is 0.5 mm or more and 5 mm or less.

32. The method for producing an electrode foil for electrolytic capacitors according to claim 28, wherein the sheet is compressed at a linear pressure of 0.55 kN/cm or more and 14 kN/cm or less.

33. The method for producing an electrode foil for electrolytic capacitors according to claim 28, wherein a thickness T₀ (mm) of the porous portion of the sheet before compression and a diameter D (mm) of the roller satisfy 380≤D/T₀≤9800.
